(19) United States
(12) Patent Application Publication
(10) Pub. No.: US 2019/0069533 A1
(43) Pub. Date: Mar. 7, 2019

(54) Systems Methods & Apparatus for Trimming a hoof of a horse

(71) Applicant: Russell Oliver St. John, Moorefield (CA)

(72) Inventor: Russell Oliver St. John, Moorefield (CA)

(21) Appl. No.: 16/121,774

(22) Filed: Sep. 5, 2018

Related U.S. Application Data
(60) Provisional application No. 62/554,171, filed on Sep. 5, 2017.

(51) Int. Cl. A01L 15/00; A01L 13/00; B26B 29/06

(52) U.S. Cl. CPC A01L 15/00; B26B 29/06; A01L 13/00

(57) ABSTRACT

Apparatus, systems and methods are provided for trimming a hoof of a horse. The apparatus is an adjustable cutting guide that includes a hoof band configured to extend around the hoof. The hoof band includes an identifier for aligning the hoof band with a mark on the hoof indicating a longitudinal axis of a leg of the horse and a cutting edge providing a cutting plane for a cutting tool. The cutting plane is perpendicular to the longitudinal axis of the leg of the horse. The cutting guide also includes a clamping structure for adjustably clamping the hoof band to the hoof at a user selectable, fixed position above a sole of the hoof when the hoof band is aligned with the mark. The systems include the cutting guide, a marking tool and an alignment tool.

### TECHNICAL FIELD

The embodiments disclosed herein relate to systems, methods and apparatus to use relative to a hoof, and in particular to systems, methods and apparatus for trimming a hoof of a horse.

### BACKGROUND

Horses tend to wear shoes to protect their hooves and to prevent damage to their feet. Typically, the wear and tear on the shoe and the normal growth and expansion of the hoof requires filing, trimming and reshoeing every six to eight weeks.

In accordance with the prior art, prior to installing a horseshoe, a farrier first removes the old shoe then determines the flatness and the plane of the bottom, ground-contacting portion of the hoof (i.e., the solar surface of the hoof). The farrier then makes corrections by peeling, cutting and/or filing to shape and flatten the bottom of the hoof. The width of the hoof is then measured and the correct horseshoe selected, shaped as required and placed against the corrected bottom of the hoof and nailed thereto.

Errors in shoeing can lead to damage to the horse's leg and foot. For example, unnecessary strain placed on components of the foot such as bones, tendons, ligaments and the like caused by an uneven solar surface may cause the horse to go lame.

Notwithstanding the importance of the flatness of the foot, the contour of the anterior (or forward) portion of the toe of the hoof is also important. A particular problem that may result from improper horseshoeing is injury to the coffin bone in the foot arising from pressure exerted by the hard, horny overlying hoofwall away from the coffin bone. When a horse lifts its hoof to walk, the heel leaves the ground first and weight it temporarily transferred to the toe. The rising hoof rotates around a transverse axis in the hoof called the break-over axis.

Prior art methods for preparing the hoof of a horse prior to applying a horseshoe pay particular attention to the lateral width and flatness of the foot. For example, U.S. Pat. No. 4,813,148 discloses a device and method for determining the flatness of a horse's hoof and for making corrections therein.

U.S. Pat. No. 5,996,698 discloses a farrier rasp that includes means for measuring the width of a horse's hoof at the same time the hoof is being filed and shaped for shoeing, thereby avoiding the necessity for the additional step of lifting the foot of the horse to measure it with a different instrument after filing.

U.S. Pat. No. 7,165,623 provides a device and a method for identifying the portion of the hoof forward of the break-over plane and for tapering or beveling the forward edge of the lower, ground-contacting surface of the hoof such that the pressure exerted by the hoofwall and the coffin bone is evenly distributed over the interface therebetween, particularly when the horse is walking or running.

There is a need for systems, methods and apparatus for trimming a horse's hoof for receiving a shoe and particularly systems, methods and apparatus that accurately provide for trimming the hoof based on the horse's own anatomy.,

### SUMMARY

According to some one aspect, there is provided an adjustable cutting guide for trimming a hoof of a horse. The cutting guide includes a hoof band configured to extend around the hoof. The hoof band includes an identifier for aligning the hoof band with a mark on the hoof indicating a longitudinal axis of a leg of the horse, and a cutting edge providing a cutting plane for a cutting tool. The cutting plane is perpendicular to the longitudinal axis of the leg of the horse. The cutting guide also includes a clamping structure for adjustably clamping the hoof band to the hoof at a user selectable, fixed position above a sole of the hoof when the hoof band is aligned with the mark.

The hoof band may be sized and shaped to conform to an outer surface of the hoof.

The clamping structure may comprise plates that are configured to press against a sole of the hoof to adjustably damp the hoof band to the hoof.

The identifier may be a pair of notches that may be vertically aligned with the mark on the hoof when the mark extends between the pair of notches.

The hoof band may comprise a fastener to secure the cutting guide to the hoof.

According to another aspect, a system is provided for trimming a hoof of a horse. The system includes a marking tool for placing a mark on the hoof when the marking tool is aligned with a midline of a sole of the hoof; an alignment tool including an indicator to extend towards a longitudinal axis of a leg of the horse for extending the mark in a direction aligned with the longitudinal axis of the leg; and an adjustable cutting guide. The adjustable cutting guide includes a hoof band configured to extend around the hoof. The hoof band includes an identifier for aligning the hoof band with the extended mark on the hoof indicating the longitudinal axis of the leg of the horse; and a cutting edge providing a cutting plane for a cutting tool, the cutting plane being perpendicular to the longitudinal axis of the leg of the horse. The cutting guide also includes a clamping structure for adjustably clamping the hoof band to the hoof at a user selectable, fixed position above the sole of the hoof when the hoof band is aligned with the extended mark.

The cutting guide may be sized and shaped to conform to an outer surface of the hoof of the horse.

The clamping structure may comprise plates that are configured to press against the sole of the hoof to adjustably clamp the hoof band to the hoof.

The identifier may be a pair of notches that may be vertically aligned with the mark on the hoof when the mark extends between the pair of notches.

The hoof band may comprise a fastener for securing the cutting guide to the hoof.

The marking tool may comprise a hook configured to extend around a toe of the hoof for placing the mark on the toe of the hoof.

The indicator may be a laser pointer and activation of the laser pointer may direct laser light towards the leg of the horse.

According to another aspect, a method is provided for trimming a hoof of a horse. The method includes; placing a mark on the hoof with a marking tool when the marking tool is aligned with a midline of a sole of the hoof; extending the mark in a direction aligned with a longitudinal axis of a leg of the horse with an alignment tool, the alignment tool having an indicator that extends towards the longitudinal axis of the leg of the horse; aligning an identifier of an adjustable cutting guide with the extended mark; the adjustable cutting guide having a hoof band extending around the hoof of the horse, the hoof band having a cutting edge to provide a cutting plane that is perpendicular to the longitudinal axis of the leg of the horse; adjustably clamping the cutting guide to the hoof at a user selectable, fixed position above a sole of the hoof with a clamping structure when the hoof band is aligned with the mark; and trimming the hoof along the cutting plane.

The placing the mark on the hoof with the marking tool may include placing the mark on a toe of the hoof.

The aligning the identifier of the adjustable cutting guide with the extended mark may include securing the band around an outer surface of the hoof.

The adjustably clamping the cutting guide to the hoof may include tightening the clamping structure of the cutting guide against the hoof.

The tightening may include extending a support of the clamping structure against a solar surface of the hoof and directing the hoof band against the outer surface of the hoof to clamp the cutting guide to the hoof.

Other aspects and features will become apparent, to those ordinarily skilled in the art, upon review of the following description of some exemplary embodiments.

### BRIEF DESCRIPTION OF THE DRAWINGS

The drawings included herewith are for illustrating various examples of systems, methods, and apparatus of the present specification, In the drawings:

FIG. 1 is a bottom view of a horse's hoof showing the solar surface (i.e. the sole) of the horse's hoof;

FIG. 2 is a perspective view of a cutting guide, according to one embodiment;

FIG. 3 is a front view of the cutting guide of FIG. 2 applied to a horse's hoof;

FIG. 4 is a bottom view of the cutting guide and clamping structure of FIG. 2;

FIG. 5 is a side view of a marking tool, according to one embodiment;

FIG. 6 is a perspective view of an alignment tool, according to one embodiment;

FIG. 7 is a perspective view of another alignment tool, according to another embodiment;

FIG. 8 is a block diagram of a method of trimming a hoof of a horse, according to one embodiment;

FIG. 9 is a bottom view of a hoof of a horse and the marking tool of FIG. 5 showing the step of applying the marking tool to a sole of the hoof of the horse, according to one embodiment;

FIG. 10 is a perspective view of a hoof of a horse and the marking tool of FIG. 5 showing the stop of applying the marking tool to a sole of the hoof of the horse;

FIG. 11 is a perspective view of a hoof of a horse and the alignment tool of FIG. 6 showing the step of applying the alignment tool to the hoof of the horse, according to one embodiment;

FIG. 12 is a back view of the cutting guide of FIG. 2 applied to a hoof of a horse, according to one embodiment; and

FIG. 13 is a bottom view of the cutting guide of FIG. 2 applied to a hoof of a horse.

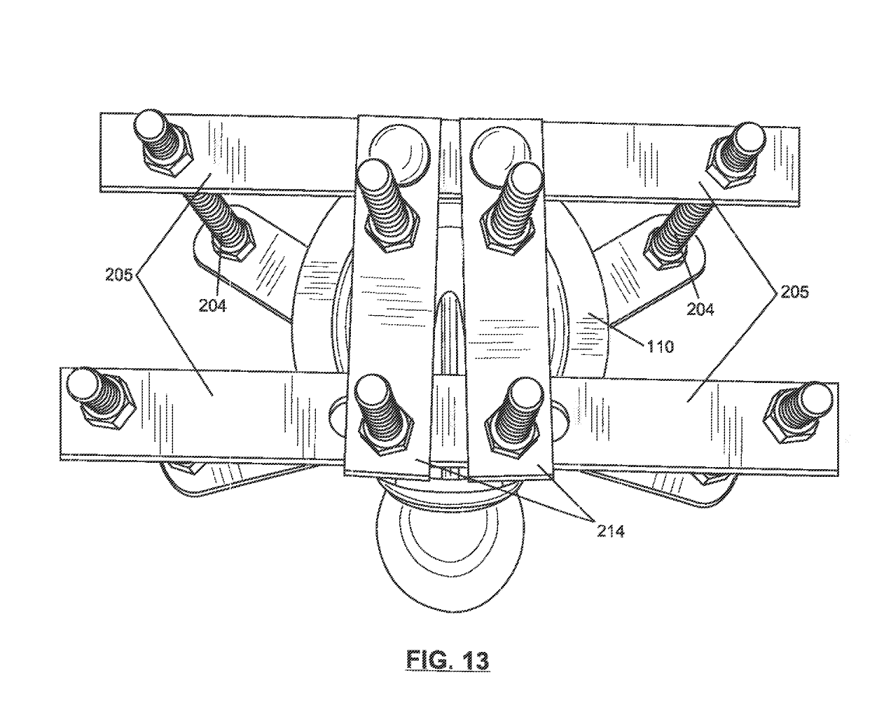

### DETAILED DESCRIPTION

Various systems, methods and apparatus will be described below to provide an example of each claimed embodiment. No embodiment described below limits any claimed embodiment and any claimed embodiment may cover systems, methods and/or apparatus that differ from those described below. The claimed embodiments are not limited to systems, methods and apparatus having all of the features of any one systems, methods and apparatus described below or to features common to multiple or all of the apparatus described below.

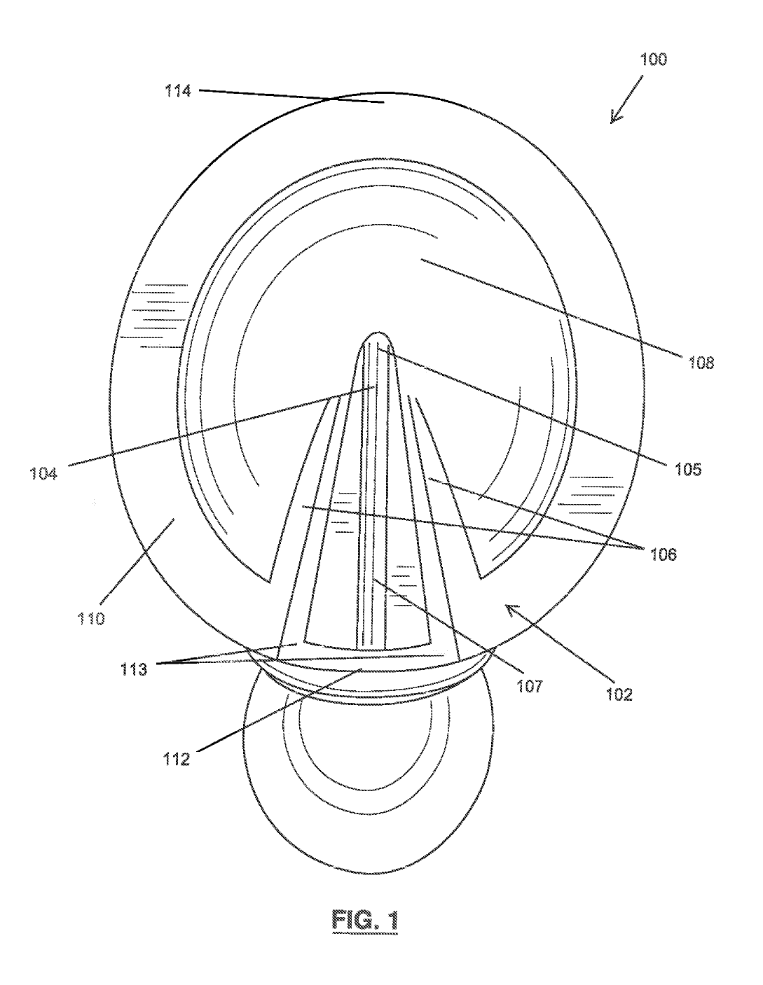

Referring now generally to FIG. 1, illustrated therein is a bottom view of a horse's hoof 100 showing a solar surface 102. The hoof 100 has a frog 104 having an apex 105. Frog 104 is a wedge-shaped structure of the hoof 100 that sits between two bars 106, as shown in FIG. 1. Apex 105 is positioned distal to a toe (e.g. a horn) 114 of the hoof 100 anterior to a heel 112. Opposite the apex 105, frog 104 expands forming two bulbs 113 of the heel 112. The concave area of the hoof distal to the bars 106 and apex 105 is the sole 108. The sole 108 is enclosed by the hoof wall 110. The sole 108 represents the part of the hoof 100 that is in contact with the ground when the horse is standing or walking. The composition of the sole 108 differs between species of horse.

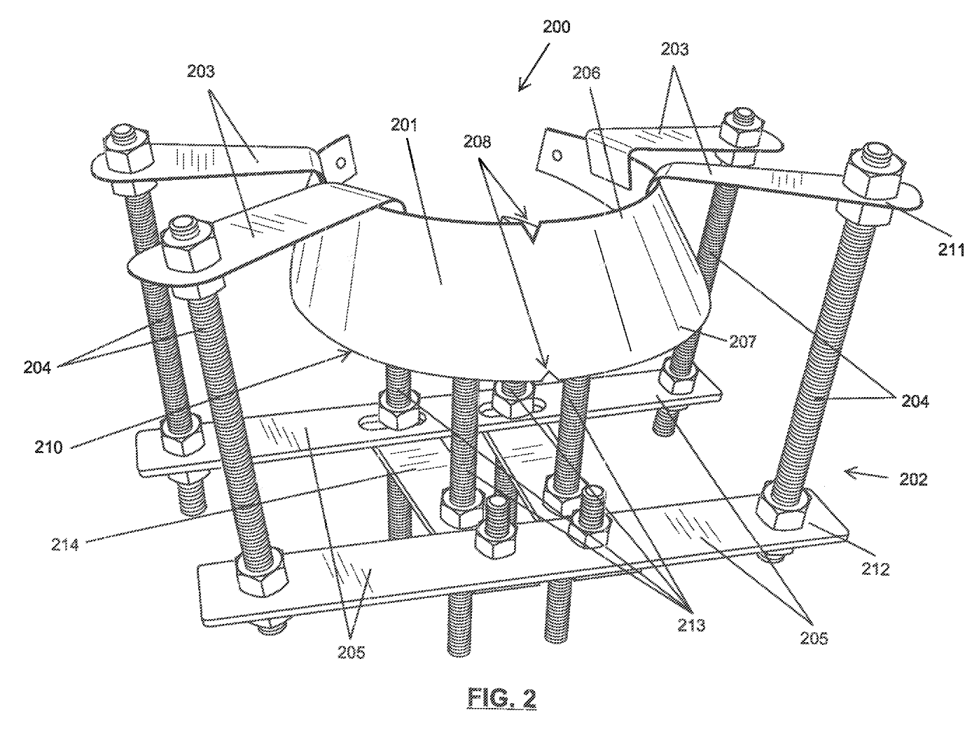

Turning to FIG. 2, illustrated therein is a perspective view of a cutting guide 200. Cutting guide 200 generally includes a hoof band 201 and a clamping structure 202.

In the embodiment shown in the drawings, hoof band 201 has a first end 206 and a second end 207 and is configured (e.g. sized and shaped) to substantially surround outer surface 115 of a horse's hoof. In one example, hoof band 201 can be sized and shaped to conform to the outer surface 115 of a horse's hoof.

Clamping structure 202 is for clamping hoof band 201 to a horse's hoof. In particular, clamping structure 202 is for clamping hoof band 201 around outer surface 115 of a horse's hoof. Hoof band 201 is rigidly coupled to clamping structure 202 at first end 206. In the embodiment shown in the Figures, clamping structure 202 uses pressure exerted against the solar surface 102 of the horse's hoof 100 to clamp the hoof band 201 to the horse's hoof 100 for trimming.

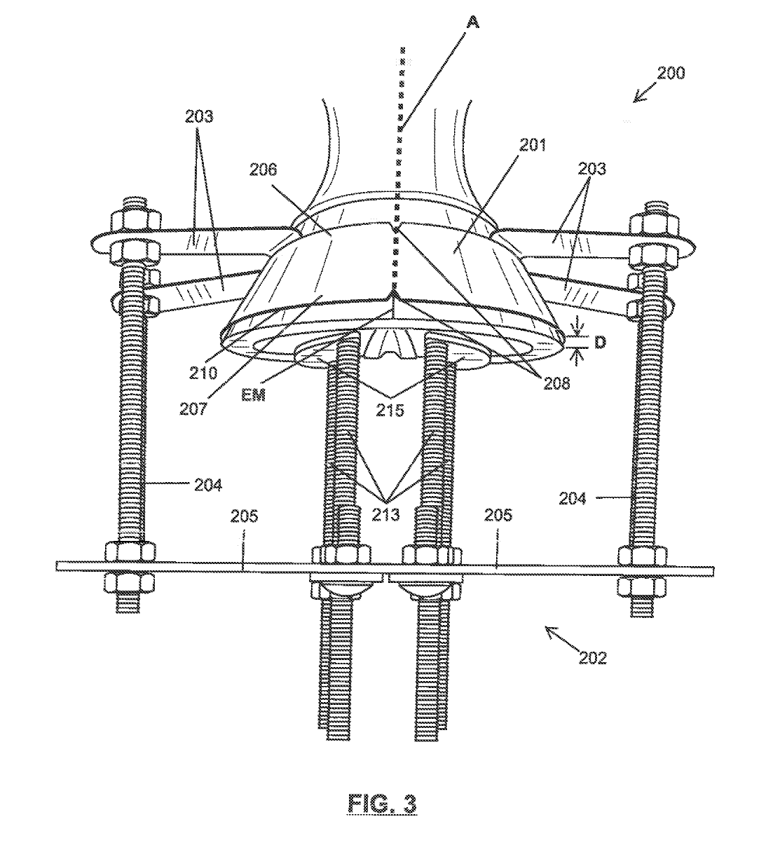

Hoof band 201 includes an identifier 208 for aligning hoof band 201 (and therefore cutting guide 200) with a longitudinal A of a leg of the horse having hoof 100 (shown in FIG. 3) represented by an extended mark EM after the mark M has placed on the hoof (as described below) has been extended in a direction aligned with the longitudinal axis A, thereby forming extended mark EM.

In the embodiment shown in FIGS. 2 to 4, identifier 208 is shown as having two notches, each notch positioned at one of first end 206 and second end 207 of hoof band 201. Identifier 208 can be positioned on hoof band 201 such that identifier 208 is visible to a user positioned in front of the horse. Hoof band 201 is aligned with the longitudinal axis A when the extended mark EM is viewable by the user in each of the notches 208.

Hoof band 201 (and therefore cutting guide 200) can be aligned with the longitudinal axis A (Le, the extended mark EM) by a user (e.g. a farrier) when the user visualizes the extended mark EM in each of the notches of identifier 208.

Hoof band 201 also includes a cutting edge 210. Cutting edge 210 is defined by second end 207 of hoof band 201 and, when hoof band 201 is clamped to a horse's hoof, cutting edge 210 extends substantially around the outer surface 115 of the horse's hoof. Cutting edge 210 provides a cutting plane for a user to use to trim the solar surface 102 of the horse's hoof 100. When hoof band 201 is aligned with the longitudinal axis A (i.e. the extended mark EM) cutting edge 210 can provide a cutting plane that is perpendicular to the longitudinal axis A.

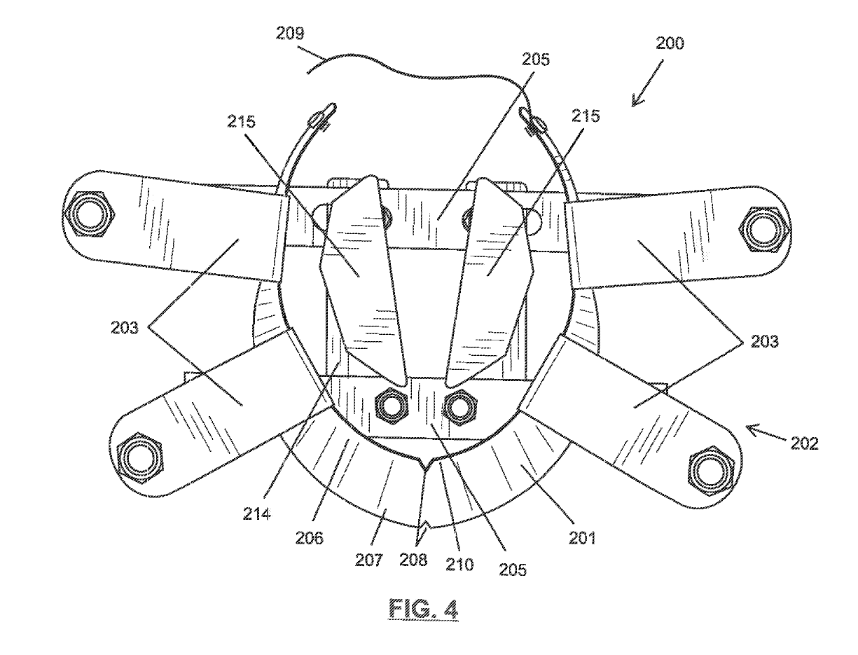

Hoof band 201 may also include a fastener 209 (see FIG. 4) for securing the hoof band 201 (and therefore cutting guide 200) to the outer surface 115 of the horse's hoof. Herein, the terms “secure” or “securing” when used in the context of the hoof band 201 and/or the cutting guide 200 refers to tightening the hoof band 201 and/or the cutting guide 200 around a horse's hoof to a degree that the hoof band 201 and/or the cutting guide 200 does not fall off of the hoof. In contrast, the terms “clamp” or “clamping” when used in the context of the hoof hand 201 and/or the cutting guide 200 refers to tightening the hoof band 201 and/or the cutting guide 200 around a horse's hoof to a degree that the hoof band 201 and/or the cutting guide 200 will not substantially move while trimming a solar surface 102 of the hoof. In the embodiment shown in FIGS. 2 to 4, fastener 209 is shown as a wire and hoof band 201 is shown as having two screws for the wire to wrap around to secure the hoof band 201 to the outer surface 115 of the horse's hoof. In this manner, hoof band 209 can be secured to the horse's hoof prior to or after clamping the It should be understood that fastener 209 can have any form appropriate for securing the hoof band 201 to the horse's hoof 100.

Cutting edge 210 can provide a selectable portion of the horse's hoof, indicated by distance D in FIG. 3, for a user to trim prior to applying a horseshoe. For instance, a user may select a distance D between the cutting edge 210 and the solar surface 102 of a horse's hoof for trimming the horse's hoof prior to securing and/or clamping hoof band 201 (and therefore cutting guide 200) to the horse's hoof. Upon selecting a distance D, the user can clamp the hoof band 201 (and therefore cutting guide 200) into place by aligning the indicator 208 of the hoof band 201 with the longitudinal axis A of the horse's leg corresponding with the hoof to be trimmed, as indicated by the extended mark EM on the hoof. In one example, to prepare the horse's hoof for applying a horseshoes, a user may choose to clamp the hoof band 201 on to the horse's hoof such that the distance D is between approximately of an inch and ⅝ of an inch.

In this manner, cutting guide 200 (and hoof band 201) is adjustable in that the hoof band 201 can be clamped to a horse's hoof (e.g. around outer surface 115 of a horse's hoof) at various user selectable, fixed positions. Specifically, clamping structure 202 provides that hoof band 201 can be clamped to a horse's hoof at a user selectable distance above solar surface 102 of the horse's hoof, as described in greater detail below. Clamping structure 202 can take any appropriate form for clamping the cutting guide 200 to a horse's hoof provided that the clamping structure 202 does not impede access to the solar surface 102 for a user to trim the horse's hoof when the band 201 is at a fixed position. In the embodiment shown in FIGS. 2 to 4, clamping structure 202 generally includes a plurality of upper supports 203, a plurality of external connecting rods 204, a plurality of lower supports 205, a plurality of internal connecting rods 213 and plates 215 (see FIGS. 3 and 4).

The plurality of upper supports 203 may include four individual supports 203 as shown in the Figures, each individual support rigidly coupled to and extending from first end 206 of hoof band 201. Each upper support 203 may be substantially evenly spaced from an adjacent upper support around hoof band 201. In this manner, identifier 208 may be substantially free for viewing by the user of cutting guide 200. Upper supports 203 are shown as being substantially planar, but can have any appropriate shape for supporting hoof band 201 against the outer surface 115 of the horse's hoof.

Each upper support 203 of the plurality of upper supports may be coupled to a respective external connecting rod 204 of the plurality of external connecting rods at a first end 211. Each external connecting rod 204 of the plurality of external connecting rods may also he coupled to a respective lower support 205 at a second end 212 of the external connecting rod 204. In the embodiments shown in FIGS. 2 to 4, external connecting rods 204 are shown as threaded rods that are coupled to each respective upper support 203 and each respective lower support 205 via two nuts (as shown in FIGS. 3 and 4). It should be noted that external connecting rods 204 may be any appropriate connector for coupling a respective upper support 203 to a respective lower support 205.

Each lower support 205 may also coupled to a respective internal connecting rod 213. in the embodiments shown in FIGS. 2 to 4, each lower support 205 may be coupled to a respective internal connecting rod 213 via an internal support 214. internal connecting rods 413 are shown as threaded rods in the Figures, but can be any appropriate connector for coupling lower supports 205 to plates 215.

In the embodiment shown in the Figures, clamping structure 202 clamps hoof band 201 on the outer surface 115 of the horse's hoof 100 by plates 215 exerting an force against the solar surface 102 of a horse's hoof as the hoof band 201 exerts a corresponding force on the outer surface 115 of the horse's hoof. Plates 215 (as shown in FIG. 4), may be thin, planar constructs that are sized and shaped to press against the solar surface 102 (e.g. the sole 108) of a horse's hoof.

When the identifier 208 of hoof band 201 is aligned with the longitudinal axis A, as represented by the extended mark EM on the horse's hoof, in one embodiment, the hoof band 201 (and therefore cutting guide 200) may be clamped into place onto a horse's hoof by tightening nuts on the external and/or internal connecting rods 204, 213 such that plates 215 exert a force upwards against solar surface 102 of a horse's hoof. When hoof band 201 is cramped onto a horse's hoof, a portion of the horse's hoof extends below cutting edge 210 of hoof band 201 for a user to trim.

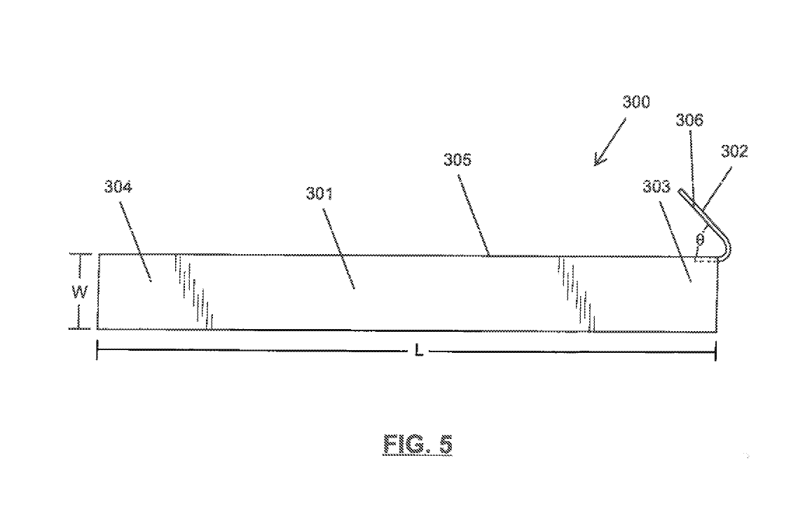

Referring now to FIG. 5, illustrated therein is a marking tool 300 according to one exemplary embodiment. The marking tool 300 generally includes a bar 301 and a hook 302.

Bar 301 has a first end 303 and a second end 304 spaced apart from first end 303. As shown in FIG. 5, bar 301 of marking tool 300 has a thin, elongated shape having a length L and a width W. with length L generally being greater than width W. Length L of bar 301 is preferably at least as long as a length of a horse's hoof to provide for bar 301 to extend from toe 114 to heel 112 of the horse's hoof 100 when the marking tool 300 is pressed against solar surface 102 of the horse's hoof 100.

As shown in FIG. 5, bar 301 is a thin, elongated object defining a straight edge 305. In this manner, bar 301 can be pressed against a solar surface of a horse's hoof 100 by a user such that the straight edge 305 is aligned with a midline of the hoof 100 (see 107 on FIG. 1). Midline 107 is an imaginary line extending between the toe 114 of the horse's hoof to the heel 112 of the horse's hoof, directly through apex 105 of frog 104, dividing the hoof into two approximately equal sized portions. Bar 301 is thin to provide for the user to view of a majority of the solar surface 102 while aligning the marking tool 300 with the midline 107 and to improve the accuracy of the user aligning the marking tool 300 with the midline 107.

Bar 301 of the marking tool 300 can be made from any appropriately rigid material, such as but not limited to steel, aluminum or the like.

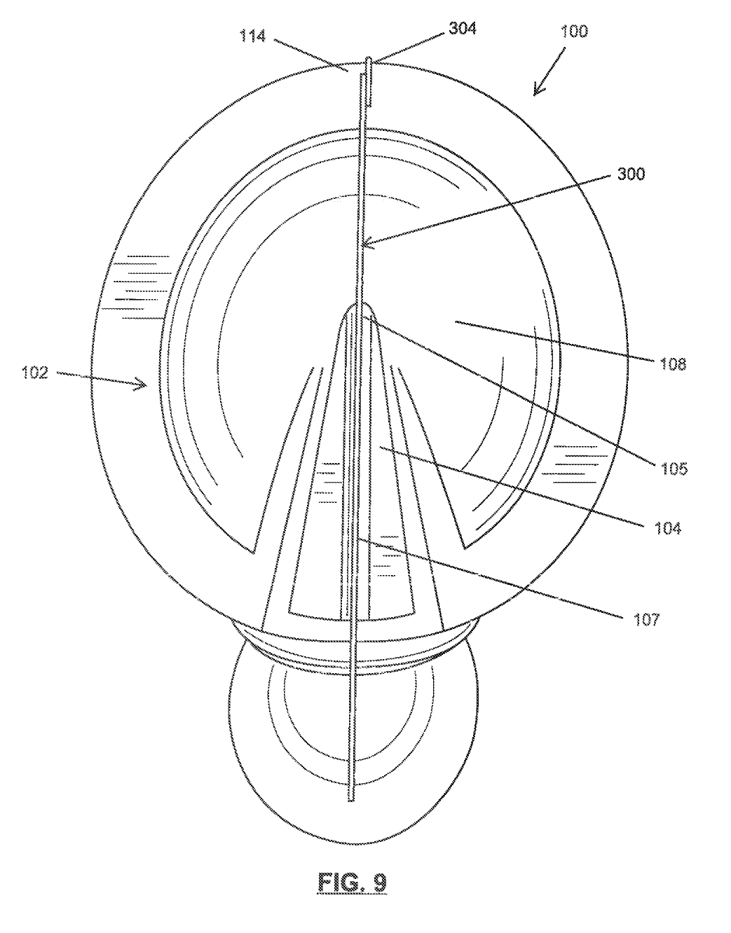

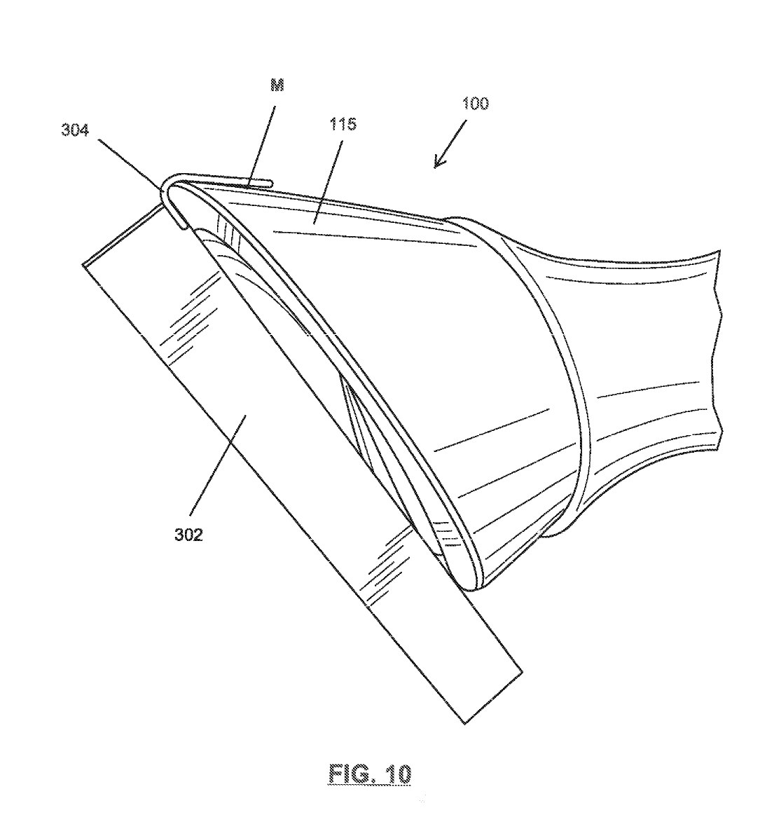

Hook 302 is coupled to bar 301 adjacent to first end 302 and extends from first end 302 in a direction towards edge 305, lateral to first end 303, as shown in FIG. 5. An angle θ of hook 302 relative to bar 301 (specifically relative to edge 305) can be selected to provide for marking a portion of the horse's hoof when the body 302, specifically edge 305, is pressed against the solar surface 102 of the horse's hoof 100. For example, as shown in FIGS. 9 and 10, described in greater detail below, hook 302 extends from first end 303 at an angle 0 approximately conforming to an angle between the ground and an outer surface 115 (see FIG. 10) of a horse's hoof for placing a mark M (see also FIG. 10) on the outer surface 115 of the horse's hoof.

Hook 302 may have a sharpened portion 306 such that, upon pressing marking tool 300 against the solar surface 102 of a horse's hoof and applying a force in a direction from the hook 302 towards the horse's hoof 100, sharpened portion 306 can mark (e.g. scratch, dent, or the like) a portion of the horse's hoof. In the embodiment shown in the Figures, hook 302 has a sharpened portion 306 that, upon pressing marking tool 300 against the solar surface 102 of a horse's hoof 100 and applying a force downwards from the hook 302 towards the outer surface 115 (see FIG. 10) of the horse's hoof 100, can mark (e.g. scratch, dent, or the like) the outer surface 115 of the horse's hoof adjacent to toe 114 of the horse's hoof.

The hook 302 of the marking tool 300 can be made from any appropriate material for marking the outer surface 115 of the horse's hoof, as described above. For example, the hook 302 can be made from steel or the like.

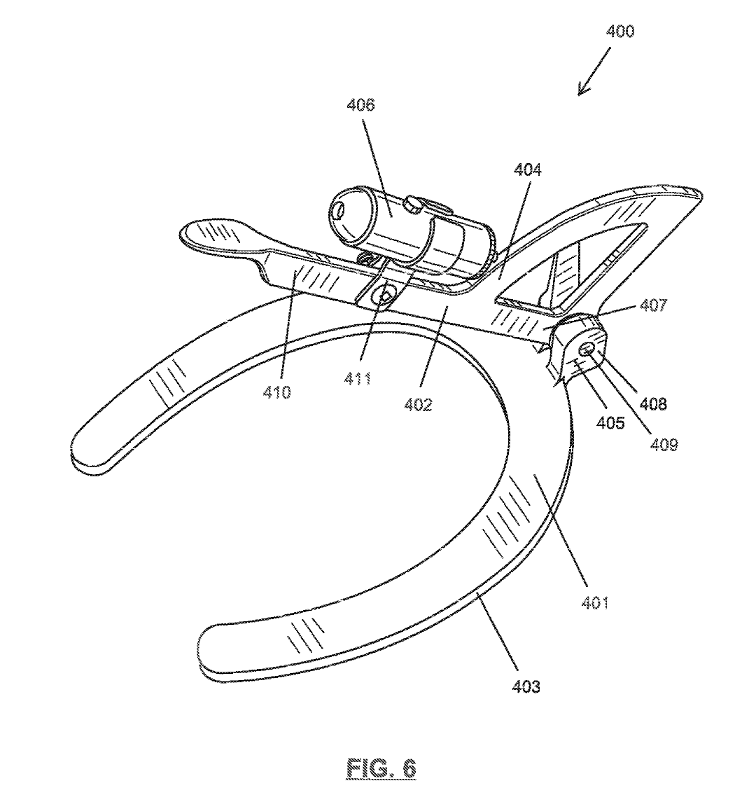

Referring now generally to see FIG. 6, illustrated therein is a perspective view of an alignment tool 400 according to one embodiment. Alignment tool 400 generally includes a base 401 movably coupled to an alignment mechanism 402.

Base 401 has a body 403 that is generally planar shaped. In the embodiment shown in FIG. 6, body 403 has a U-shape much like that of a traditional horseshoe. Accordingly, body 403 generally has a width and a length approximately equal to the width and the length of a horse's hoof so that a horse can stand on the base 401 during use of the alignment tool 400, In this manner, base 401 is sized and shaped to be placed against a solar surface 102 of a horse's hoof as alignment mechanism 402 is used to extend the mark M placed on a portion of the horse's hoof, such as the outside surface 115 of the horse's hoof, towards a lower limb of the horse. Further, base 401 is also generally planar to provide for ease of placement against the solar surface 102 of a horse's hoof. Base 401 can be made from any appropriately rigid material, such as but not limited to steel or the like.

Alignment mechanism 402 generally includes an arm 404 and an indicator 406, In the embodiment shown in FIG. 6, arm 404 is coupled to and rotatable about base 401 at a lower portion 407 of arm 404. Arm 404 is hingedly coupled to body 403 of base 401 such as by a hinge 405. Hinge 405 may, for example, include two extensions 408, each defining an aperture there though, rigidly coupled to base 401 and positioned on either side of arm 402. in this embodiment, a pin 409 may pass through each of the apertures the respective extensions 409 as well as through a corresponding aperture of alignment mechanism 402 there between to hingedly couple alignment mechanism 402 to base 401.

Indicator 406 of alignment tool 400 is for extending the mark M provided on a horse's hoof by the marking tool 300 in a direction towards a lower limb of the horse. As shown in FIG. 6, indicator 406 may be coupled to arm 402 at an upper portion 410. Indicator 406 is positioned to extend toward a lower limb of the horse for extending the mark M on the horse's hoof in a direction towards the lower limb of the horse (see FIG. 6).

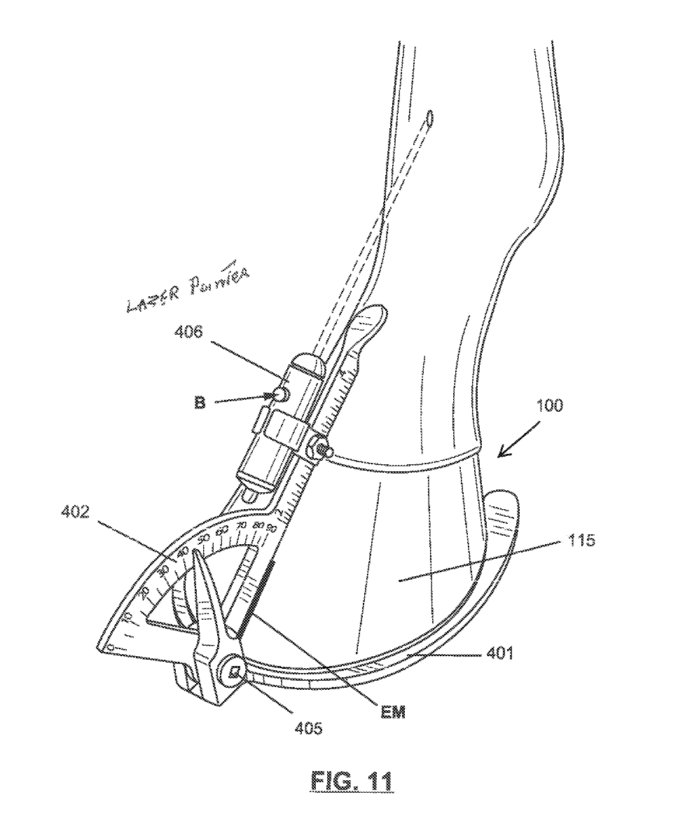

For example, in the embodiment shown in the Figures, indicator 406 is shown as a laser pointer coupled to arm 402 by holder 412. Upon placement of a horse's hoof on base 401 with the toe 114 of the hoof positioned adjacent to hinge 405, activation of indicator 406 directs laser light towards the lower limb of the horse. Extension of the mark M on the hoof of the horse in the direction of the laser light towards the lower limb of the horse (e.g. such that the laser light impacts the cannon bone (i.e. the middle portion of the lower limb visible to the farrier)) can provide a reference for determining an accurate plane of contact between the hoof and an underlying surface. Use of the alignment tool 400 is described in greater detail below with reference to FIG. 11.

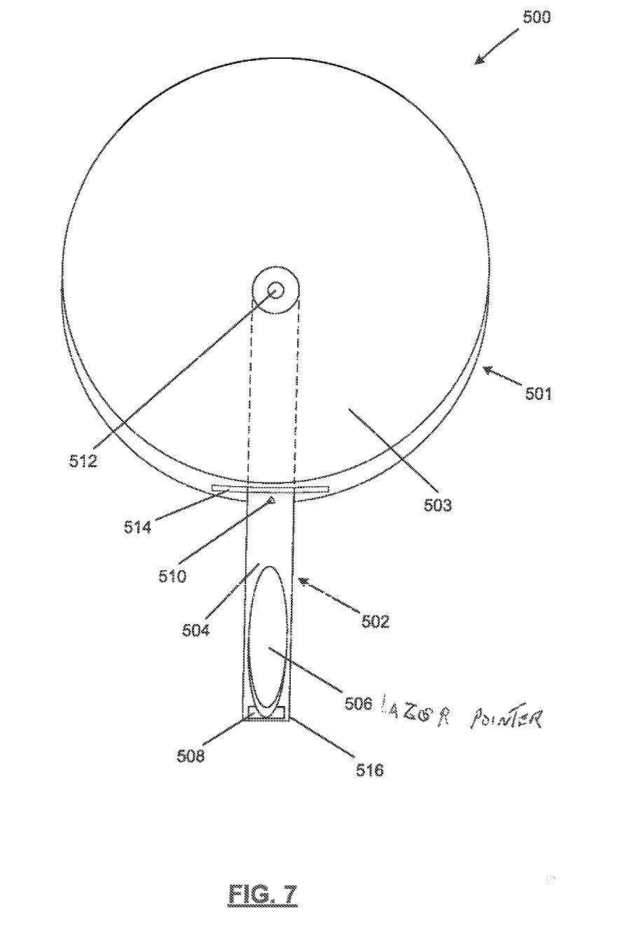

Referring now to FIG. 7, illustrated therein is a perspective view of another embodiment of an alignment tool. In this embodiment, alignment tool 500 generally includes a base 501 moveably coupled to an alignment mechanism 502.

Base 501 has a body 503 that is generally planar shaped. in the embodiment shown in FIG. 7, body 403 has a generally disc-like shape where body 403 is hollow. Body 503 is generally sized and shaped so that a horse can stand on the base 501 during use of the alignment tool 500. For example, base 501 is sized and shaped to be placed against a solar surface 102 of a horse's hoof as alignment mechanism 502 is used to extend the mark M placed on a portion of the horse's hoof, such as the outside surface 115 of the horse's hoof, in a direction towards a lower limb of the horse. Further, base 501 is also generally planar to provide for ease of placement against the solar surface 102 of a horse's hoof. Base 501 can be made from any appropriately rigid material, such as but not limited to steel or the like.

Alignment mechanism 502 generally includes an arm 504 and an indicator 506. Arm 504 is rotatably coupled to and extends from base 501. In the embodiment shown in FIG. 7, arm 504 is coupled to base 501 at rotation point 512 and extends from rotation point 512 through a slot 514 in body 503 of base 501. Arm 504 is rotatable about rotation point 512 within slot 514 such that slot 514 bounds arm 504 and restricts rotation of arm 504 about rotation point 512. Arm 504 is rotatable about rotation point 512 to provide for extending indicator 506 towards a leg of the horse when the horse's hoof is placed on base 501.

As shown in FIG. 7, arm 504 also includes a guide 510. Guide 510 is positioned on arm 504 adjacent to base 501. Guide 510 provides a visual reference for a user to align the arm 504 with the mark M placed on the horse's hoof when the horse's hoof is placed on base 501. The arm 504 and the mark M are aligned when the mark M of the horse's hoof is directly adjacent guide 510.

Indicator 506 is hingedly coupled to arm 504 at a free end 516 of arm 504 extending through slot 514. As shown in FIG. 7, indicator 506 can be hingedly coupled to arm 504 extending from base 501 by a hinge 508 such that indicator 506 extends towards body 503 of base 501.

Indicator 506 of alignment tool 500 is or extending the mark M provided on a horse's hoof by the marking tool 300 in a direction towards a leg of the horse. In this manner, alignment tool 500 can provide for extending mark M on the horse's hoof into extended mark EM, where extended mark EM represents longitudinal axis A of the leg of the horse corresponding to the hoof placed on base 501. As shown in FIG. 7, indicator 506 may be coupled to arm 504 at a portion 516 extending from base 501. Indicator 506 is positioned on arm 504 to be able to extend toward the leg of the horse for extending the mark M on the horse's hoof in a direction parallel to (e.g. representing) the longitudinal axis A of the leg of the horse corresponding to the hoof 100 placed on the base 501.

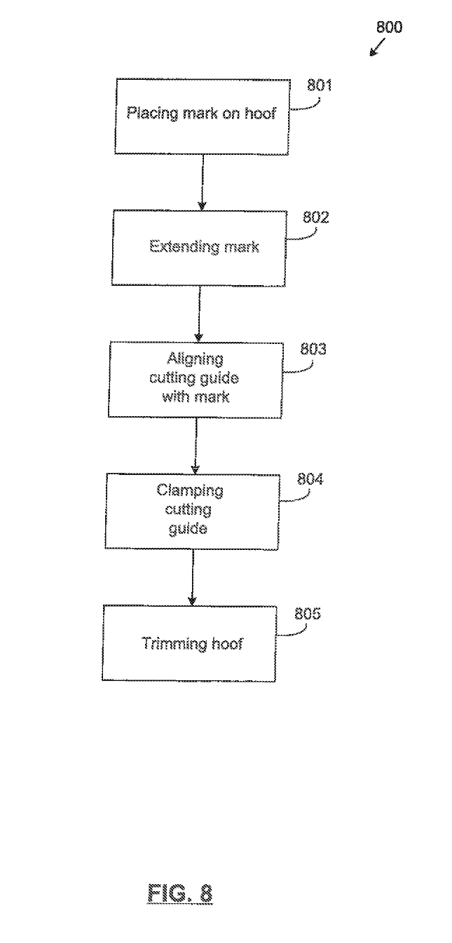

Referring now to FIG. 8, a method 800 is also provided for trimming a horse's hoof. Method 800 may include the steps of: placing a mark on the hoof with a marking tool when the marking tool is aligned with a midline of a sole of the hoof (step 801); extending the mark in a direction aligned with longitudinal axis A of a leg of the horse with an alignment tool, the alignment tool having an indicator that extends towards the longitudinal axis A (step 802); aligning an identifier of an adjustable cuffing guide with the extended mark; the adjustable cutting guide having a hoof band extending around the hoof of the horse, the hoof band having a cutting edge to provide a cutting plane that is perpendicular to the longitudinal axis A (step 803); adjustably clamping the cutting guide to the hoof at a user selectable, fixed position above a sole of the hoof with a damping structure when the hoof band is aligned with the mark (step 804); and trimming the hoof along the cutting plane with a cutting tool(step 805).

At step 801, the marking tool 300 is placed against solar surface 102 of a horse's hoof. A bottom view of a horse's hoof 100 with the marking tool placed against solar surface 102 is shown in FIG. 8. To place a mark M on the hoof 100, marking tool 300 is first aligned with a midline 107 of the hoof 100 passing through apex 105 of frog 104. When the marking tool 300 is positioned to be aligned with midline 107, marking tool 300 is said to be horizontally aligned with hoof 100 (i.e. marking tool 300 divides solar surface 102 into two approximately evenly sized halves). In this embodiment, while maintaining the marking tool in this horizontally aligned position with midline 107, pressure can be applied to a portion of the marking tool 300 to place a mark M on the horse's hoof 100. in the embodiment shown in FIGS. 9 and 10, for example, pressure can be manually applied to hook 304 of marking tool 300 as hook 304 extends around toe 114 of the horse's hoof against the outer surface 115 of the horse's hoof 100 to place a mark M on outer surface 115 of the horse's hoof 100 adjacent to toe 114. Mark M is said to be horizontally aligned on the horse's hoof 100 when mark M is place on the horse's hoof 100 when the marking tool 300 is horizontally aligned with midline 107.

At step 802, described below with reference to FIG. 11, an alignment tool 400 can be used to extend the mark M along the hoof 100 in a direction towards a lower limb of the horse, As previously described, alignment tool 400 includes base 401 movably coupled to alignment mechanism 402, and the alignment mechanism 402 has an indicator 406 that, when activated, extends towards a leg of the horse having the hoof 100 (e.g. directly towards the cannon bone of the leg having the hoof 100) to provide a reference line for extending the mark M. Mark M can therefore be extended by a user using alignment tool 400 to create extended mark EM being parallel to the longitudinal axis A of the leg of the horse having hoof 100. Extended mark EM on hoof 100 provides for a user to align the identifier 208 of the hoof band 201 (and therefore the cutting guide 200) with the longitudinal axis A of the leg having hoof 100. Cutting edge 210 of hoof band 201 provides a cutting plane for a user to use as a reference plane when trimming the solar surface 102 of the hoof 100 when the hoof band 201 (and therefore the cutting guide 200) is aligned with the longitudinal axis A of the leg having hoof 100,

As shown in FIG. 11, to extend the mark Mon hoof 100, the base 401 of alignment tool 400 is placed against solar surface 102 of the horse's hoof with arm 402 aligned with the mark M. Specifically, in the embodiment shown in FIG. 11, arm 402 is shown aligned with the mark M placed on outer surface 115 of the horse's hoof 100. Arm 402 of the alignment mechanism 400 can then be rotated to rest against outer surface 115 of the horse's hoof 100. While maintaining base 401 against the solar surface 102 and arm 402 aligned with mark M, indicator 408 can be activated (e.g. by pressing button B shown on FIG. 11) to direct indicator 406 towards the lower limb of the horse. In the example shown in FIG. 11, the indicator 406 is a laser pointer and, when activated, directs laser light towards the lower limb of the horse. When the indicator 406 extends directly towards the lower limb of the horse (e.g. directly towards the cannon bone of the lower limb of the horse having the hoof 100), the mark M can be manually extended along arm 402 to provide extended mark EM (as shown in FIG. 11).

When indicator 406 is activated, if the light (for example) extending from the indicator 406 is not directed towards (i.e. does not strike) the lower limb of the horse having the hoof 100, the user can manually adjust the placement of base 401 against solar surface 102 of the hoof 100 until the light is directed towards (Le. does strike) the lower limb of the horse haying the hoof 100. When the light is directed towards (i.e. does strike) the lower limb of the horse having the hoof 100 (e.g. directly strikes the cannon bone of the lower limb of the horse having the hoof 100), the mark M can be extended to produce extended mark EM.

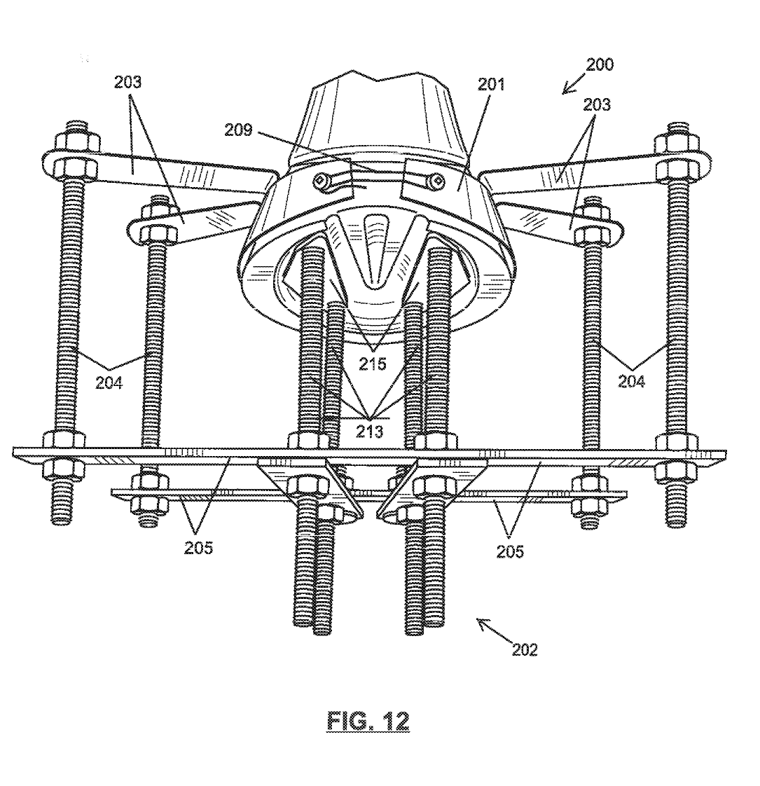

At step 803, hoof band 201 is applied to the hoof 100. As previously described, hoof band 201 is adjustable and extends around the hoof 100 of the horse. In one example, as shown in FIG. 12, at step 703 hoof band 201 can be secured to hoof 100 by tightening fastener 209 of hoof band 201. Hoof band 201 can then be aligned with the extended mark EM. For instance, in the embodiment shown in the Figures, identifier 208 of the hoof band 201 can be vertically aligned with the extended mark EM on the hoof 100 by visualizing the extended mark EM in each of the notches of identifier 208.

At step 804, after vertically aligned the hoof band 201 with the extended mark EM, hoof band 201 (and therefore cutting guide 200) is clamped to the hoof 100 using clamping structure 202. For example, hoof band 201 (and therefore cutting guide 200) can be clamped onto hoof 100 by tightening nuts on the external and/or internal connecting rods 204, 213 such that plates 215 exert a force upwards against solar surface 102 of a horse's hoof. As previously described, cutting edge 210 provides a cutting plane for the user to use when trimming the hoof of the horse to apply a horse shoe that is perpendicular to the longitudinal axis A of the leg of the horse. When hoof band 201 is clamped onto a horse's hoof, a portion of the horse's hoof extends below cutting edge 210 of hoof band 201 for a user to trim. Hoof band 201 can be clamped to hoof 100 with the cutting edge 210 spaced a selectable distance D (see FIG. 3) above the solar surface 102 of the hoof 100. In this manner, the user can select an amount of the hoof 100 to trim while providing an solar surface 102 that, when trimmed, is perpendicular to the longitudinal axis A of the leg of the horse.

At step 805, the hoof 100 is trimmed along the cutting plane provided by the cutting edge 210 of the hoof band 201. In one embodiment, the hoof 100 can be trimmed using a cutting toot The cutting tool can be any appropriate tool for trimming the hoof of the horse.

While the above description provides examples of one or more apparatus, methods, or systems, it will be appreciated that other apparatus, methods, or systems may be within the scope of the claims as interpreted by one of skill in the art.

1. An adjustable cutting guide for trimming a hoof of a horse, the cutting guide comprising:
a) a hoof band configured to extend around the hoof, the hoof band comprising:
i) an identifier for aligning the hoof band with a mark on the hoof indicating a longitudinal axis of a leg of the horse; and
ii) a cutting edge providing a cutting plane for a cutting tool, the cutting plane being perpendicular to the longitudinal axis of the leg of the horse; and
b) a clamping structure for adjustably clamping the hoof band to the hoof at a user selectable, fixed position above a sole of the hoof when the hoof band is aligned with the mark.

2. The cutting guide of claim 1. wherein the hoof band is sized and shaped to conform to an outer surface of the hoof.

3. The cutting guide of claim 1, wherein the clamping structure comprises plates that are configured to press against a sole of the hoof to adjustably clamp the hoof band to the hoof.

4. The cutting guide of claim 1, wherein the identifier is a pair of notches and the identifier is vertically aligned with the mark on the hoof when the mark extends between the pair of notches.

5. The cutting guide of claim 1, wherein the hoof band comprises a fastener to secure the cutting guide to the hoof.

6. A system for trimming a hoof of a horse, the system comprising:
a) a marking tool for placing a mark on the hoof when the marking tool is aligned with a midline of a sole of the hoof;
b) an alignment tool comprising an indicator to extend towards a longitudinal axis of a leg of the horse for extending the mark in a direction aligned with the longitudinal axis of the leg; and
c) an adjustable cutting guide comprising:
i) a hoof band configured to extend around the hoof, the hoof band comprising:
i. an identifier for aligning the hoof band with the extended mark on the hoof indicating the longitudinal axis of the leg of the horse; and
ii. a cutting edge providing a cutting plane for a cutting tool, the cutting plane being perpendicular to the longitudinal axis of the leg of the horse; and
ii) a clamping structure for adjustably clamping the hoof band to the hoof at a user selectable, fixed position above the sole of the hoof when the hoof band is aligned with the extended mark. The system of claim 6, wherein the cutting guide is sized and shaped to conform to an outer surface of the hoof of the horse.

8. The system of claim 6, wherein the clamping structure comprises plates that are configured to press against the sole of the hoof to adjustably damp the hoof band to the hoof,

9. The system of claim 5, wherein the identifier is a pair of notches and the identifier is vertically aligned with the mark on the hoof when the mark extends between the pair of notches.

10. The system of claim 6, wherein the hoof band comprises a fastener for securing the cutting guide to the hoof.

11. The system of claim 6, wherein the marking tool comprises a hook configured to extend around a toe of the hoof for placing the mark on the toe of the hoof.

12. The system of claim 6, wherein the indicator is a laser pointer and activation of the laser pointer directs laser light towards the leg of the horse.

13. A method for trimming a hoof of a horse, the method comprising:
a) placing a mark on the hoof with a marking tool when the marking tool is aligned with a midline of a sole of the hoof;
b) extending the mark in a direction aligned with a longitudinal axis of a leg of the horse with an alignment tool. the alignment tool having an indicator that extends towards the longitudinal axis of the leg of the horse;
c) aligning an identifier of an adjustable cutting guide with the extended mark, the adjustable cutting guide having a hoof band extending around the hoof of the horse, the hoof band having a cutting edge to provide a cutting plane that is perpendicular to the longitudinal axis of the leg of the horse;
d) adjustably clamping the cutting guide to the hoof at a user selectable, fixed position above a sole of the hoof with a clamping structure when the hoof band is aligned with the mark; and
e) trimming the hoof along the cutting plane.

14. The method of claim 13, wherein the placing the mark on the hoof with the marking tool includes placing the mark on a toe of the hoof.

15. The method of claim 13, wherein the aligning the identifier of the adjustable cutting guide with the extended mark includes securing the band around an outer surface of the hoof.

16. The method of claim 13, wherein the adjustably damping the cutting guide to the hoof includes tightening the clamping structure of the cutting guide against the hoof.

17. The method of claim 16, wherein the tightening includes extending a support of the clamping structure against a solar surface of the hoof and directing the hoof band against the outer surface of the hoof to damp the cutting guide to the hoof.
